(19) United States
(12) Patent Application Publication
(10) Pub. No.: US 2025/0192478 A1
(43) Pub. Date: Jun. 12, 2025

(54) HIGH-VOLTAGE CONNECTOR CAPABLE OF REALIZING JOGGING CONTROL OVER HIGH-VOLTAGE INTER-LOCK

(71) Applicant: Changchun Jetty Automotive Technology Co., Ltd., Changchun, Jilin (CN)

(72) Inventors: Chao WANG, Jilin (CN); Jibiao CAO, Jilin (CN)

(21) Appl. No.: 18/840,797

(22) PCT Filed: Feb. 17, 2023
(86) PCT No.: PCT/CN2023/076686

§ 371 Date: Aug. 22, 2024

(30) Foreign Application Priority Data
Feb. 24, 2022 (CN) 202210176329.8

(51) Int. Cl. H01R 13/639; H01R 13/629; H01R 13/703; H01R 13/707

(52) U.S. Cl. CPC H01R 13/639; H01R 13/7032; H01R 13/707; H01R 13/62933; H01R 2201/26

(57) ABSTRACT

Disclosed in the present disclosure is a high-voltage connector for jogging control over high-voltage inter-lock, including a socket housing and a plug housing. A high-voltage male terminal and a high-voltage female terminal, which are electrically connectable to each other by being plugged with each other, are provided in the socket housing and the plug housing respectively. The high-voltage connector further includes a high-voltage inter-lock system, on which a jogging control structure is provided. The jogging control structure is configured to control, by means of a short-distance action, the high-voltage inter-lock system to be powered on or powered off, so as to control an electrical connectivity between the high-voltage male terminal and the high-voltage female terminal.

### RELATED APPLICATION

The present disclosure claims priority to Chinese Patent Application No. 202210176329.8, entitled “high-voltage connector for jogging control over high-voltage inter-lock”, and filed on Feb. 24, 2022, which is hereby incorporated by reference in its entirety.

### TECHNICAL FIELD

The present disclosure relates to the technical field of high-voltage connectors of new energy vehicles, and particularly to a high-voltage connector for jogging control over high-voltage inter-lock.

### BACKGROUND

With the rapid development of new energy vehicles, the high-voltage connectors of new energy vehicles are constantly updated. However, safety issues related to high-voltage connectors remain a critical concern. The high-voltage connectors of new energy vehicles include high-voltage inter-lock devices, which are used to confirm the integrity of the entire high-voltage electrical system with a small current of 12V. All high-voltage components and wiring harness connectors of the whole vehicle must be mounted in place without short circuit or open circuit. When a controller detects that a High Voltage Inter-lock (HVIL) loop is disconnected or the integrity is damaged, it initiates essential safety measures. When detecting that the high-voltage inter-lock circuit is disconnected and judging that there is a risk in the vehicle system, a Battery Management System (BMS) selects different essential safety measures according to the vehicle conditions at that time.

Until the vehicle is stationary and the high-voltage inter-lock forms a complete loop, a high-voltage loop is powered on. When a high-voltage inter-lock loop is disconnected, the high-voltage loop is powered off immediately. When a high-voltage connector needs to be plugged or unplugged for vehicle maintenance, the high-voltage inter-lock can ensure the safety of operators: when the high-voltage connector is to be unplugged, the high-voltage inter-lock loop must be disconnected before the high-voltage loop is disconnected; when the high-voltage connector is to be plugged, the high-voltage inter-lock circuit is connected and conducted after a power terminal is contacted and conducted; otherwise the power terminal will be still in a live state during plugging and unplugging of the high-voltage connector, which is easy to cause arcing and endanger the personal safety of operators.

As illustrated in FIGS. 17 and 18, the high-voltage inter-lock devices in the prior art for high-voltage connection all use a pin terminal 201 to cooperate with a socket terminal 202 to form a high-voltage inter-lock loop. Since both the pin terminal 201 and the socket terminal 202 have a certain length, when an operator plugs or unplugs the high-voltage connector, he has to plug or unplug for a certain distance to disconnect or connect the inter-lock loop. However, during the plugging and unplugging process, the high-voltage loop is still in a live state, which means that the operator's operation for a period of time is still high-voltage live plugging and unplugging, thus posing a risk to the operator's safety and creating a potential safety hazard.

Therefore, based on years of experiences and practices in related industries, the inventor proposes a high-voltage connector for jogging control over high-voltage inter-lock, so as to overcome the defects in the prior art.

### SUMMARY

The present disclosure aims to provide a high-voltage connector for jogging control over high-voltage inter-lock, which solves the problems mentioned in the section of Background, realizes a jogging control over high-voltage inter-lock, such that a high-voltage inter-lock system can be switched on and switched off within an extremely short period of time, thereby greatly reducing a distance of live-line plugging and unplugging, and controlling the power-on and power-off of a high-voltage loop within an extremely short period of time.

The objective of the present disclosure is achieved by a high-voltage connector for jogging control over high-voltage inter-lock, including a socket housing and a plug housing. A high-voltage male terminal and a high-voltage female terminal, which are electrically connectable to each other by being plugged with each other, are provided in the socket housing and the plug housing, respectively. The high-voltage connector further includes a high-voltage inter-lock system, on which a jogging control structure is provided. The jogging control structure is configured to control, by means of a short-distance action, the high-voltage inter-lock system to be powered on or powered off, so as to control an electrical connectivity state between the high-voltage male terminal and the high-voltage female terminal.

Based on the above description, the high-voltage connector for jogging control over high-voltage inter-lock of the present disclosure achieves the following advantageous effect:

The high-voltage connector for jogging control over high-voltage inter-lock of the present disclosure is provided with a jogging control structure, which can realize jogging control over high-voltage inter-lock, such that a high-voltage inter-lock system can be switched on and switched off within an extremely short period of time, thereby greatly reducing the reassembly time and the plugging distance, reducing the distance of live-line plugging and unplugging, achieving the jogging control, reducing the potential safety hazards, and ensuring the connection stability of the high-voltage inter-lock system. The present disclosure effectively solves the problem of live-line plugging and unplugging of the high-voltage connectors during plugging and unplugging, reduces the potential safety hazards during plugging and unplugging of the high-voltage connector, and ensures the personal safety of operators.

### BRIEF DESCRIPTION OF DRAWINGS

The following drawings are only for schematic illustration and explanation of the present disclosure, rather than limiting the scope of the present disclosure. In the drawings:

FIG. 1 illustrates a schematic diagram of a high-voltage connector for jogging control over high-voltage inter-lock according to the present disclosure when a high-voltage inter-lock system is switched on;

FIG. 2 illustrates a cross-sectional view taken along A-A in FIG. 1 when a jogging control slider is adopted for a jogging control structure according to the present disclosure;

FIG. 3 illustrates an enlarged view taken at I in FIG. 2;

FIG. 4 illustrates a schematic diagram of a high-voltage connector for jogging control over high-voltage inter-lock according to the present disclosure when a high-voltage inter-lock system is switched off;

FIG. 5 illustrates a cross-sectional view taken along B-B in FIG. 4 when a jogging control slider is adopted for a jogging control structure according to the present disclosure;

FIG. 6 illustrates an enlarged view taken at II in FIG. 5;

FIG. 7 illustrates an assembly diagram of a jogging control structure according to the present disclosure;

FIG. 8 illustrates an exploded diagram of a jogging control structure according to the present disclosure;

FIG. 9 illustrates a structural diagram of a high-voltage inter-lock ejector block according to the present disclosure;

FIG. 10 illustrates a structural diagram of a high-voltage inter-lock terminal according to the present disclosure;

FIG. 11 illustrates an exploded diagram of a socket housing structure before being assembled according to the present disclosure;

FIG. 12 illustrates a schematic diagram of a socket housing structure after being assembled according to the present disclosure;

FIG. 13 illustrates an exploded diagram of a plug housing structure before being assembled according to the present disclosure;

FIG. 14 illustrates a schematic diagram of a plug housing structure after being assembled according to the present disclosure;

FIG. 15 illustrates a principle diagram when a high-voltage connector for jogging control over high-voltage inter-lock according to the present disclosure is unplugged;

FIG. 16 illustrates a principle diagram when a high-voltage connector for jogging control over high-voltage inter-lock according to the present disclosure is plugged;

FIG. 17 illustrates a principle diagram when a high-voltage connector of the prior art is unplugged;

FIG. 18 illustrates a principle diagram when a high-voltage connector of the prior art is plugged;

FIG. 19 illustrates a schematic diagram when a positioning projection is provided on a jogging control housing according to the present disclosure;

FIG. 20 illustrates a schematic diagram when a positioning block is provided in a socket housing according to the present disclosure;

FIG. 21 illustrates a schematic diagram of a process of mounting a microswitch on a socket housing;

FIG. 22 illustrates a schematic diagram of a rear end of a socket housing on which a microswitch is mounted;

FIG. 23 illustrates a schematic diagram of a front end of a socket housing on which a microswitch is mounted;

FIG. 24 illustrates a cross-sectional view taken along A-A in FIG. 1 when a microswitch is adopted for a jogging control structure according to the present disclosure; and

FIG. 25 illustrates a cross-sectional view taken along B-B in FIG. 4 when a microswitch is adopted for a jogging control structure according to the present disclosure.

In the drawings,

100: high-voltage connector for jogging control over high-voltage inter-lock; 1: socket housing; 11: connecting post; 12: positioning block; 13: positioning clamping groove; 14: positioning claw; 2: dual self-locking structure; 3: high-voltage inter-lock terminal; 31: transition signal line; 4: jogging control structure; 41: return spring; 42: high-voltage inter-lock short-distance connection reed; 421: first accommodating curved groove; 422: second accommodating curved groove; 423: connecting tab; 424: reed insertion portion; 43: jogging control slider; 431: guide post; 432: slider body; 433: reed connecting plate; 434: tab clamping groove; 435: reed plugging groove; 44: jogging control housing; 441: guide post through-hole; 442: positioning protrusion; 45: microswitch; 451: switch housing; 452: switch button; 5: high-voltage male terminal; 6: plug housing; 7: rocker arm; 8: high-voltage inter-lock ejector block; 81: ejector block enclosure frame; 82: abutting hole; 9: high-voltage female terminal; 201: pin terminal; 202: jack terminal.

### DETAILED DESCRIPTION OF EMBODIMENTS

For a clearer understanding of the technical features, objectives and effects of the present disclosure, specific embodiments of the present disclosure will now be described with reference to the drawings.

The specific embodiments of the present disclosure described here are only for the purpose of explaining the present disclosure, and should not be construed as limiting the present disclosure in any way. Under the teaching of the present disclosure, persons skilled in the art can conceive any possible variation based on the present disclosure, which should be regarded as falling within the scope of the present disclosure. It should be noted that when an element is referred to as being “provided” on another element, it may be directly on another element or there may be an intervening element. When an element is regarded as being “connected” to another element, it may be directly connected to another element or there may be an intervening element. The terms ‘mount’ and ‘connect’ should be understood in a broad sense. For example, a connection may be a mechanical connection or an electrical connection, or an internal communication between two elements, or a direct connection, or an indirect connection through an intermediate medium. For persons of ordinary skills in the art, the specific meanings of the above terms can be understood according to the specific conditions. The terms “vertical”, “horizontal”, “upper”, “lower”, “left”, “right” and similar expressions used herein are for illustration only rather than indicating a unique embodiment.

Unless otherwise defined, all technical and scientific terms used herein have the same meanings as those commonly understood by persons skilled in the art of the present disclosure. The terms used in the Specification of the present disclosure are only for the purpose of describing the specific embodiments, rather than limiting the present disclosure. The term “and/or” used herein includes any and all combinations of one or more of the related items listed.

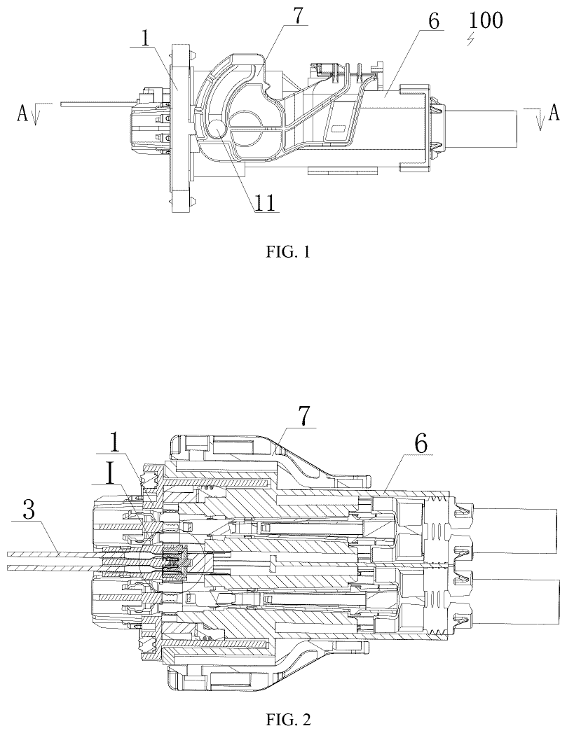

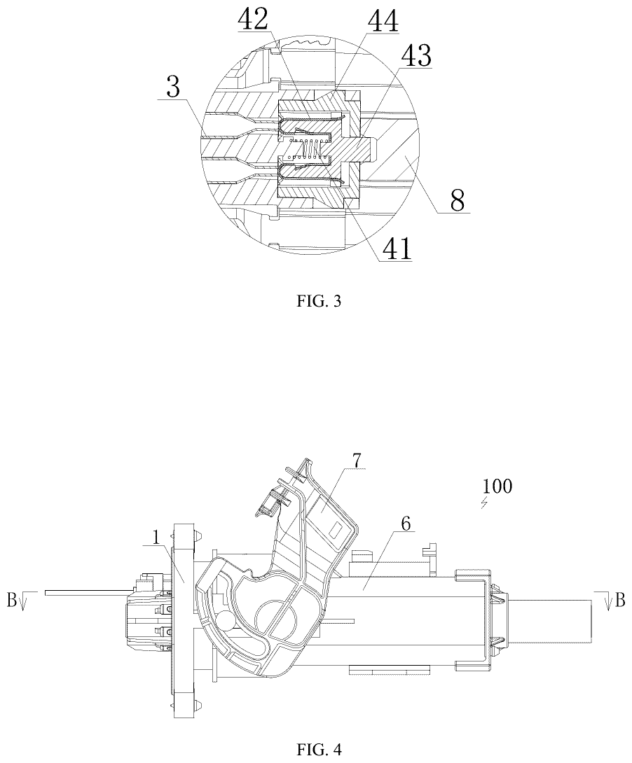

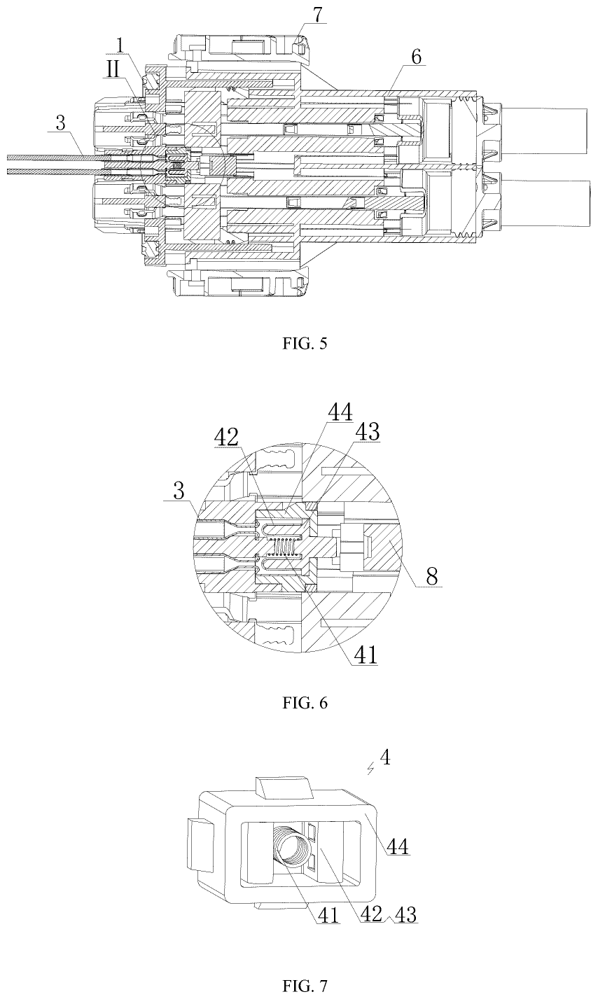

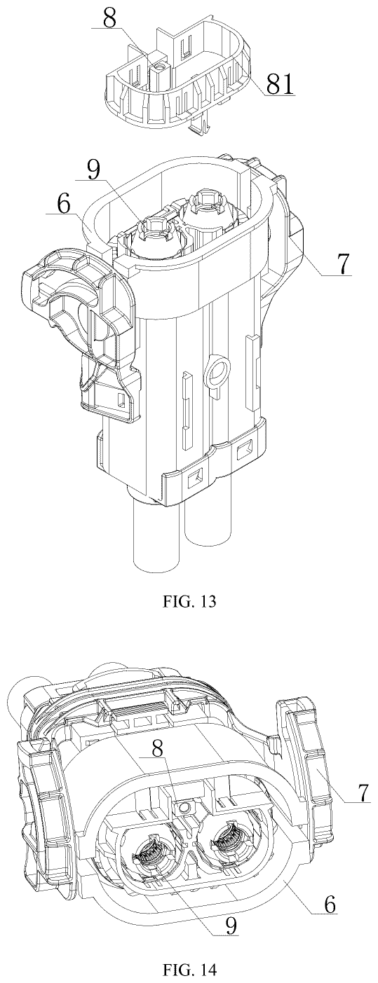

As illustrated in FIGS. 1 to 14 and 19 to 25, the present disclosure provides a high-voltage connector 100 for jogging control over high-voltage inter-lock, including a socket housing 1 and a plug housing 6. A high-voltage male terminal 5 and a high-voltage female terminal 9, which are electrically connectable to each other by being plugged with each other, are provided in the socket housing 1 and the plug housing 6, respectively (as illustrated in FIGS. 12 and 14). The high-voltage connector further includes a high-voltage inter-lock system configured to control an electrical connectivity state between the high-voltage male terminal 5 and the high-voltage female terminal 9. By plugging the high-voltage male terminal 5 and the high-voltage female terminal 9 with each other and further moving them toward each other for a first distance, the high-voltage inter-lock system is powered on, and then the high-voltage male terminal 5 and the high-voltage female terminal 9 are electrically connected; by moving the high-voltage male terminal 5 and the high-voltage female terminal 9 away from each other for the first distance, the high-voltage inter-lock system is powered off and at the same time the high-voltage male terminal 5 and the high-voltage female terminal 9 are electrically disconnected, and by further moving the high-voltage male terminal 5 and the high-voltage female terminal 9 away from each other for a second distance, they are separated from each other.

The high-voltage inter-lock system is provided with a jogging control structure 4 capable of controlling the high-voltage inter-lock system to be powered on or powered off by means of a short-distance action, so as to control an electrical connectivity state between the high-voltage male terminal 5 and the high-voltage female terminal 9. The term “short-distance” refers to the on-off control distance of the jogging control structure being much shorter than the plug-unplug distance of the existing pin-jack type high-voltage inter-lock device.

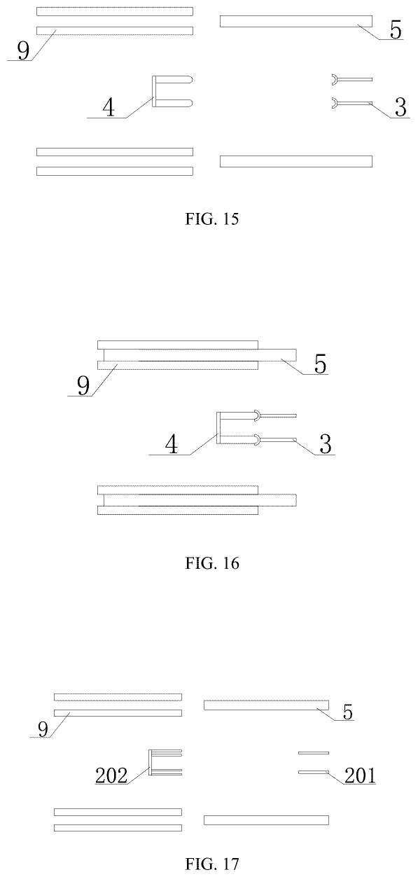

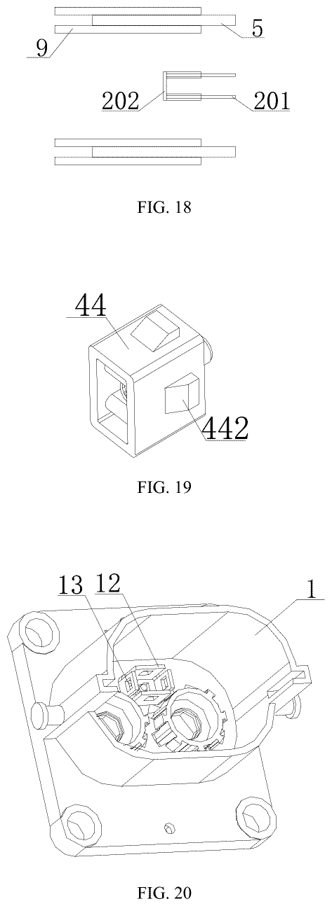

As illustrated in FIGS. 15 and 16, when an operator unlocks a dual lock and just starts to unplug the high-voltage connector (the jogging control structure can be switched off within an extremely short distance and an extremely short period of time), the high-voltage inter-lock system is switched off, and a high-voltage loop is immediately powered off (i.e., the high-voltage male terminal and the high-voltage female terminal are electrically disconnected). When the operator plugs the high-voltage connector, only at a moment at which the plugging between the high-voltage male terminal and the high-voltage female terminal is completed, the high-voltage inter-lock system is switched on and the high-voltage loop is powered on (i.e., the high-voltage male terminal and the high-voltage female terminal are electrically connected), which effectively solves the problem of live-line plugging and unplugging of the high-voltage connector during plugging and unplugging, reduces the potential safety hazards when plugging and unplugging the high-voltage connector, and ensures the personal safety of the operator.

The existing high-voltage inter-lock devices are all of a pin-jack type, and during plugging of the high-voltage connector, the high-voltage inter-lock terminal has a long reassembly time and a long plugging distance, which leads to a long distance of live-line plugging and unplugging of the high-voltage connector. The high-voltage connector for jogging control over high-voltage inter-lock of the present disclosure is provided with a jogging control structure, which can realize jogging control over high-voltage inter-lock, such that a high-voltage inter-lock system can be switched on and switched off within an extremely short period of time, thereby greatly reducing the reassembly time and the plugging distance, reducing the distance of live-line plugging and unplugging, achieving the jogging control, reducing the potential safety hazards, and ensuring the connection stability of the high-voltage inter-lock system.

Further, as illustrated in FIGS. 2, 3, 5, 6, 7 and 8, the high-voltage inter-lock system includes two high-voltage inter-lock terminals 3 provided in the socket housing, and the jogging control structure 4 includes a jogging control housing 44 provided in the socket housing 1 and a high-voltage inter-lock ejector block 8 provided in the plug housing 6. A high-voltage inter-lock short-distance connection reed 42 is slidably provided in the jogging control housing 44, and the high-voltage inter-lock ejector block 8 is capable of ejecting and pushing the high-voltage inter-lock short-distance connection reed 42 to slide to be electrically connected to the high-voltage inter-lock terminals 3.

Further, as illustrated in FIGS. 2, 3, 5, 6, 7 and 8, a jogging control slider 43 is slidably provided in the jogging control housing 44, the high-voltage inter-lock short-distance connection reed 42 is connected to a side of the jogging control slider 43 away from the high-voltage inter-lock ejector block 8, and a return spring 41 is provided on and abutted against a side of the high-voltage inter-lock short-distance connection reed 42 away from the high-voltage inter-lock ejector block 8; the high-voltage inter-lock ejector block 8 is capable of ejecting and pushing the jogging control slider 43 and the high-voltage inter-lock short-distance connection reed 42 to slide towards the high-voltage inter-lock terminals 3, and the return spring 41 is capable of pushing the jogging control slider 43 to slide away from the high-voltage inter-lock terminals 3.

Further, as illustrated in FIGS. 2, 3, 5, 6, 7 and 8, a side of the jogging control housing 44 close to the high-voltage inter-lock terminals is provided with an opening, a sidewall of the jogging control housing 44 away from the high-voltage inter-lock terminals 3 is provided with a guide post through-hole 441, and the jogging control slider 43 is provided with a guide post 431 slidably inserted into the guide post through-hole 441; the high-voltage inter-lock ejector block 8 is capable of ejecting the guide post 431 to push the jogging control slider 43.

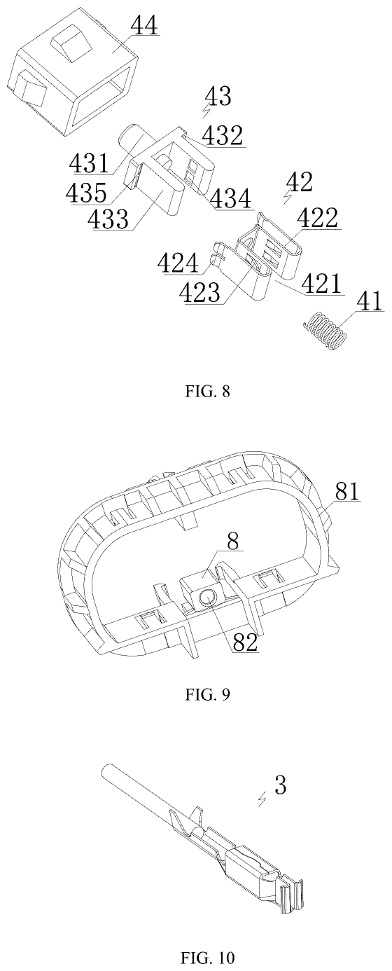

Further, as illustrated in FIG. 8, the high-voltage inter-lock short-distance connection reed 42 is bent in a bow shape to form a first accommodating curved groove 421, two sides of which form a second accommodating curved groove 422, respectively, and the return spring 41 is provided in the first accommodating curved groove 421. The jogging control slider 43 includes a slider body 432 provided with two reed connecting plates 433 which can be clamped in the second accommodating curved groove 422, respectively.

As illustrated in FIGS. 19 and 20, in this embodiment, a positioning block 12 is provided in the socket housing 1, a positioning clamping groove 13 is provided on the positioning block 12, a positioning protrusion 442 is provided on the jogging control housing 44, and the positioning protrusion 442 can be clamped in the positioning clamping groove 13. In this embodiment, the number of the positioning protrusions 442 and the number of the positioning clamping grooves 13 are four.

Further, as illustrated in FIG. 8, two sidewalls of the first accommodating curved groove 421 are provided with a connecting tab 423, respectively, the two reed connecting plates 433 are provided with a tab clamping groove 434, respectively, and each of the connecting tabs 423 can be clamped in the corresponding tab clamping groove 434.

Further, as illustrated in FIG. 8, two ends of the high-voltage inter-lock short-distance connection reed 42 are provided with a reed insertion portion 424, respectively, the slider body 432 is provided with reed plugging grooves 435, and the reed insertion portions 424 can be plugged into the reed plugging grooves 435, respectively.

Further, as illustrated in FIG. 9, the high-voltage inter-lock ejector block 8 is provided on an ejector block enclosure frame 81, which can be detachably clamped in the plug housing 6; an end of the high-voltage inter-lock ejector block 8 is provided with an abutting hole 82, which can abut against the guide post 431 to push the guide post 431 to slide.

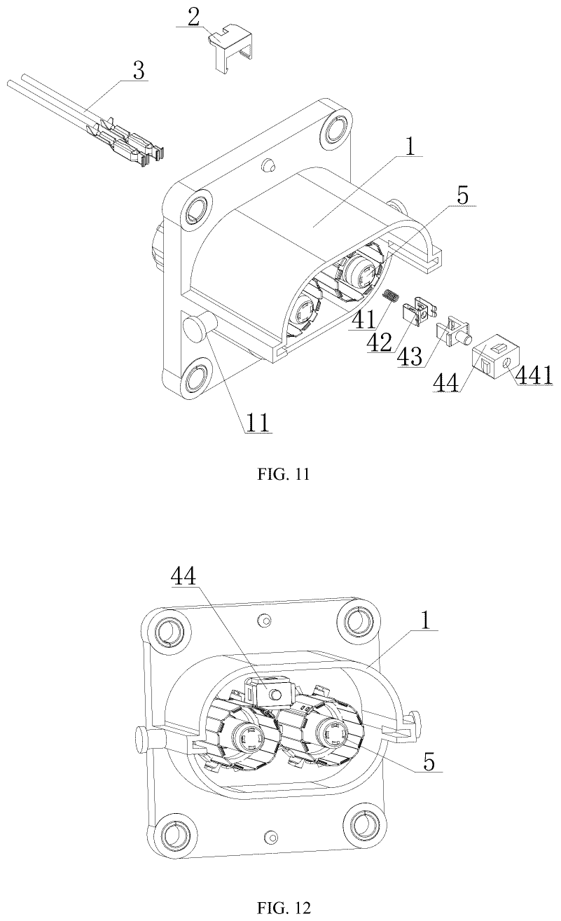

Further, as illustrated in FIGS. 10 and 11, the high-voltage inter-lock terminals 3 are plugged into the socket housing 1 from an end away from the plug housing (i.e., a tail of the socket housing), and the high-voltage inter-lock terminals 3 are locked and fixed in the socket housing 1 by a dual self-locking structure 2. The dual self-locking structure 2 may be a Terminal Position Assurance (TPA) clip, which can lock the terminals and enhance the retention of the terminals in the connector. The TPA achieves a dual protection and limiting for the terminals in the connector, and is also known as a dual self-locking structure, which is applied in a harsh environment or when a greater unplugging force is required. The TPA is plugged to lock the high-voltage inter-lock terminals, and when the high-voltage inter-lock terminals are matched with the TPA, the movement of the high-voltage inter-lock terminals is well limited, which achieves an anti-retreat function and ensures the connection stability of the high-voltage inter-lock.

In another specific embodiment of the present disclosure, the jogging control housing 44, the jogging control slider 43, the high-voltage inter-lock short-distance connection reed 42 and the return spring 41 in the aforementioned jogging control structure 4 may be replaced with a microswitch, which may be a microswitch in the prior art.

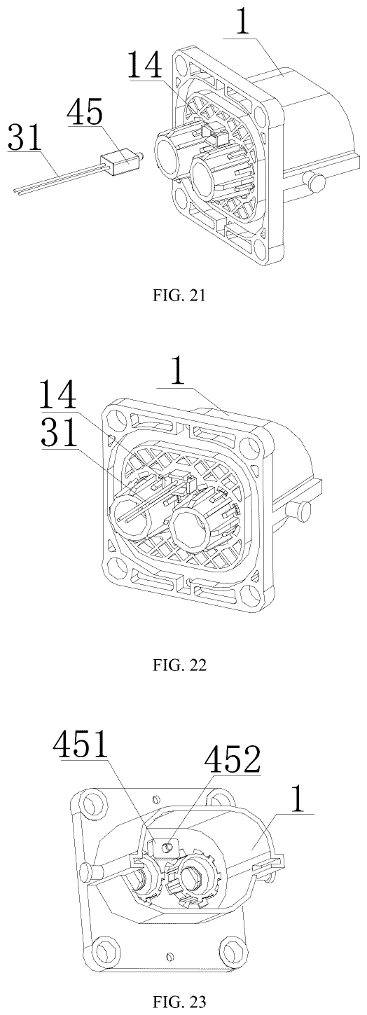

Further, as illustrated in FIGS. 21 to 25, the jogging control structure 4 includes a microswitch 45 provided in the socket housing 1 and a high-voltage inter-lock ejector block 8 provided in the plug housing 6. The microswitch 45 includes a switch housing 451 and a switch button 452, a first end of the switch button 452 protrudes out of the switch housing 451, and a second end of the switch button 452 can be electrically connected to two transition signal lines 31, which are electrically connected to the high-voltage inter-lock system. The high-voltage inter-lock ejector block 8 can eject and push the switch button 452 to power on the high-voltage inter-lock system. Further, as illustrated in FIGS. 21 and 22, the socket housing 1 is provided with a switch through-hole having a shape matched with a shape of the switch housing 451. A side (rear end) of the switch through-hole away from the plug housing 6 is provided with a positioning claw 14, and the switch housing 451 is inserted into the switch through-hole and is fixed by the positioning claw 14. In this embodiment, the switch housing 451 has a rectangular cross section, and the number of the positioning claws 14 are four, and the four positioning claws 14 are clamped and abutted against four sides of the switch housing 451, respectively.

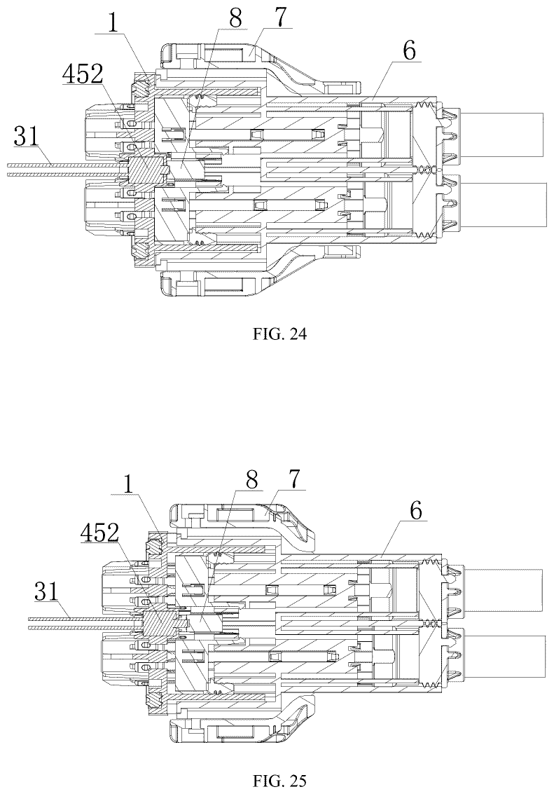

As illustrated in FIGS. 21, 22 and 23, during mounting, the second end of the switch button 452 is connected to two transition signal lines 31, and the microswitch 45 is plugged into the socket housing 1 from a rear end of the socket housing 1 (i.e., a side of the socket housing 1 away from the plug housing 6). The positioning claw 14 blocks the switch housing 451 of the microswitch 45 to prevent the microswitch 45 from retreating, thereby achieving an anti-retreat function; the socket house 1 restricts the microswitch 45 from moving forward. During plugging, the high-voltage inter-lock ejector block 8 ejects and pushes the switch button 452; when the high-voltage connector is about to be reassembled in place, the microswitch 45 is closed, the high-voltage inter-lock system is switched on, and the high-voltage loop, where the high-voltage male terminal 5 is electrically connected to the high-voltage female terminal 9, is powered on, such that the plugging of the high-voltage connector is completed, as illustrated in FIG. 24. When the high-voltage connector is unplugged, the high-voltage inter-lock ejector block 8 is separated from the microswitch 45, the high-voltage inter-lock system is switched off, and the high-voltage loop, where the high-voltage male terminal 5 is electrically connected to the high-voltage female terminal 9, is powered off, as illustrated in FIG. 25.

Further, as illustrated in FIGS. 1, 4, 11, 12, 13 and 14, a rocker arm 7 is provided on a sidewall of the plug housing 6, a connecting groove is provided on the rocker arm 7, a connecting post 11 is provided on a sidewall of the socket housing 1, and the connecting groove is disposed to slidably sleeve the connecting post 11.

The use process of the high-voltage connector 100 for jogging control over high-voltage inter-lock of the present disclosure is as follows:

During plugging, the high-voltage female terminal 9 moves forward along with the plug housing 6, and continues to move forward after being contacted with the high-voltage male terminal 5 in the socket housing 1. At this time, the high-voltage inter-lock ejector block 8 in the plug housing 6 has not been contacted with the jogging control slider 43 (i.e., guide post 431) in the socket housing 1, and the high-voltage inter-lock system is not switched on, such that the high-voltage male terminal 5 and the high-voltage female terminal 9 are in a powered off state. When the rocker arm 7 is about to be reassembled in place, the high-voltage inter-lock ejector block 8 is contacted with the guide post 431 of the jogging control slider 43, and the high-voltage inter-lock ejector block 8 pushes the jogging control slider 43 to slide until the high-voltage inter-lock short-distance connection reed 42 is completely in close contact with the high-voltage inter-lock terminals 3. At this time, the return spring 41 is compressed, the high-voltage inter-lock system is switched on, the high-voltage loop, where the high-voltage male terminal 5 is electrically connected to the high-voltage female terminal 9, is powered on, and the plugging of the high-voltage connector is completed, as illustrated in FIGS. 1, 2 and 3. From the time when the high-voltage inter-lock short-distance connection reed 42 starts to come into contact with the high-voltage inter-lock terminals 3 until the completion of the plugging of the high-voltage connector, a relative movement distance between the high-voltage male terminal 5 and the high-voltage female terminal 9 is very short, which greatly reduces the distance of live-line plugging and unplugging and reduces the potential safety hazards.

During unplugging, the rocker arm 7 is lifted upward, the plug housing 6 starts to move backwards, and the high-voltage inter-lock ejector block 8 in the plug housing 6 also starts to move backwards. At this time, the return spring 41 urges the jogging control slider 43 to move backwards until the high-voltage inter-lock short reed 42 is completely separated from the high-voltage inter-lock terminals 3. At this time, the high-voltage loop, where the high-voltage male terminal 5 is electrically disconnected from the high-voltage female terminal 9, is powered off, and the plug housing 6 and the high-voltage female terminal 9 therein only move for a very short distance, as illustrated in FIGS. 4, 5 and 6. As the plug housing 6 continues to move backwards, the high-voltage male terminal 5 and the high-voltage female terminal 9 are completely separated from each other. During unplugging, a live-line unplugging distance of the high-voltage connector is greatly shortened, and the potential safety hazards are reduced.

Based on the above description, the high-voltage connector for jogging control over high-voltage inter-lock of the present disclosure has the following advantageous effects:

The high-voltage connector for jogging control over high-voltage inter-lock of the present disclosure is provided with a jogging control structure, which can realize jogging control over high-voltage inter-lock, such that the high-voltage inter-lock system can be switched on and switched off within an extremely short period of time, thereby greatly reducing the reassembly time and the plugging distance, reducing the distance of hot plugging and unplugging, achieving the jogging control, reducing the potential safety hazards, and ensuring the connection stability of the high-voltage inter-lock system. The present disclosure effectively solves the problem of live-line plugging and unplugging of the high-voltage connector during plugging and unplugging, reduces the potential safety hazards during plugging and unplugging of the high-voltage connector, and ensures the personal safety of operators.

Those described above are just schematic embodiments of the present disclosure, rather than limitations thereto. Any equivalent substitution or amendment made by persons skilled in the art without deviating from the concept and principle of the present disclosure should fall within the protection scope of the present disclosure.

What is claimed is:

1. A high-voltage connector for jogging control over high-voltage inter-lock, comprising a socket housing and a plug housing, wherein a high-voltage male terminal and a high-voltage female terminal, which are electrically connectable to each other by being plugged with each other, are provided in the socket housing and the plug housing, respectively; and
the high-voltage connector further comprises a high-voltage inter-lock system, on which a jogging control structure is provided, wherein the jogging control structure is configured to control, by means of a short-distance action, the high-voltage inter-lock system to be powered on or powered off, so as to control an electrical connectivity state between the high-voltage male terminal and the high-voltage female terminal.

2. The high-voltage connector for jogging control over high-voltage inter-lock according to claim 1, wherein the high-voltage inter-lock system comprises two high-voltage inter-lock terminals provided in the socket housing, and the jogging control structure comprises a jogging control housing provided in the socket housing and a high-voltage inter-lock ejector block provided in the plug housing; and
a high-voltage inter-lock short-distance connection reed is slidably provided in the jogging control housing, and the high-voltage inter-lock ejector block is capable of ejecting and pushing the high-voltage inter-lock short-distance connection reed to slide to be electrically connected to the high-voltage inter-lock terminals.

3. The high-voltage connector for jogging control over high-voltage inter-lock according to claim 2, wherein a jogging control slider is slidably provided in the jogging control housing, the high-voltage inter-lock short-distance connection reed is connected to a side of the jogging control slider away from the high-voltage inter-lock ejector block, and a return spring is provided on and abutted against a side of the high-voltage inter-lock short-distance connection reed away from the high-voltage inter-lock ejector block; and
the high-voltage inter-lock ejector block is capable of ejecting and pushing the jogging control slider and the high-voltage inter-lock short-distance connection reed to slide towards the high-voltage inter-lock terminals, and the return spring is capable of pushing the jogging control slider to slide away from the high-voltage inter-lock terminals.

4. The high-voltage connector for jogging control over high-voltage inter-lock according to claim 3, wherein a side of the jogging control housing close to the high-voltage inter-lock terminals is provided with an opening, a sidewall of the jogging control housing away from the high-voltage inter-lock terminals is provided with a guide post through-hole, and the jogging control slider is provided with a guide post slidably inserted into the guide post through-hole; and
the high-voltage inter-lock ejector block is capable of ejecting the guide post to push the jogging control slider.

5. The high-voltage connector for jogging control over high-voltage inter-lock according to claim 3, wherein the high-voltage inter-lock short-distance connection reed is bent in a bow shape to form a first accommodating curved groove, two sides of which form a second accommodating curved groove, respectively, and the return spring is provided in the first accommodating curved groove; and
the jogging control slider comprises a slider body provided with two reed connecting plates which are clamped in the second accommodating curved grooves, respectively.

6. The high-voltage connector for jogging control over high-voltage inter-lock according to claim 5, wherein two sidewalls of the first accommodating curved groove are provided with a connecting tab, respectively, the two reed connecting plates are provided with a tab clamping groove, respectively, and each of the connecting tabs is clamped in the corresponding tab clamping groove.

7. The high-voltage connector for jogging control over high-voltage inter-lock according to claim 5, wherein two ends of the high-voltage inter-lock short-distance connection reed are provided with a reed insertion portion, respectively, the slider body is provided with reed plugging grooves, and the reed insertion portions are inserted into the reed plugging grooves, respectively.

8. The high-voltage connector for jogging control over high-voltage inter-lock according to claim 5, wherein a positioning block is provided in the socket housing, a positioning clamping groove is provided on the positioning block, a positioning protrusion is provided on the jogging control housing, and the positioning protrusion is clamped in the positioning clamping groove.

9. The high-voltage connector for jogging control over high-voltage inter-lock according to claim 4, wherein the high-voltage inter-lock ejector block is provided on an ejector block enclosure frame, which is detachably clamped in the plug housing; and
an end of the high-voltage inter-lock ejector block is provided with an abutting hole, which is capable of abutting against the guide post to push the guide post to slide.

10. The high-voltage connector for jogging control over high-voltage inter-lock according to claim 4, wherein the high-voltage inter-lock terminals are plugged into the socket housing from an end away from the plug housing, and the high-voltage inter-lock terminals are locked and fixed in the socket housing by a dual self-locking structure.

11. The high-voltage connector for jogging control over high-voltage inter-lock according to claim 1, wherein the jogging control structure comprises a microswitch provided in the socket housing and a high-voltage inter-lock ejector block provided in the plug housing;
the microswitch comprises a switch housing and a switch button, a first end of the switch button protrudes out of the switch housing, and a second end of the switch button is capable of being electrically connected to two transition signal lines, which are electrically connected to the high-voltage inter-lock system; and
the high-voltage inter-lock ejector block is capable of ejecting and pushing the switch button to power on the high-voltage inter-lock system.

12. The high-voltage connector for jogging control over high-voltage inter-lock according to claim 11, wherein the socket housing is provided with a switch through-hole, a side of the switch through-hole away from the plug housing is provided with a positioning claw, and the switch housing is inserted into the switch through-hole and is fixed by the positioning claw.
